(19) United States
(12) Patent Application Publication
(10) Pub. No.: US 2012/0153088 A1
(43) Pub. Date: Jun. 21, 2012

(54) WING RIG

(76) Inventors: Oyvind Lokeberg, Trondheim (NO); Ole Jorgen Bryn, Trondheim (NO); Hans Holmefjord, Oslo (NO); Hans Iver Lange, Trondheim (NO); Endre Jacobsen, Hakadal (NO); Andreas Barkhall, Trondheim (NO)

(21) Appl. No.: 13/381,796

(22) PCT Filed: Jul. 2, 2010
(86) PCT No.: PCT/NO10/00265

§ 371 Date: Mar. 6, 2012

(30) Foreign Application Priority Data
Jul. 3, 2009 (NO) 20092514

(51) Int. Cl. B64C 39/02; B64D 17/00

(52) U.S. Cl. 244/4 A

(57) ABSTRACT

A wingrig comprising an integrated harness and wingsuit is presented. The wingrig gives improved ergonomic conditions compared to the state of art today. The wing suit comprises leading structures which can receive parts of the harness. A solution regarding the locking loop(s) contributes to giving a near optimal aerodynamic shape of the container. The wingrig may further comprise a locking system which allows release of the canopy and other equipment with one move of the jumper.

### 1. THE AREA OF THE INVENTION

The dream of human flight has through history been a driving force for innovation. However, the dream of unassisted flight has, up to recent time, been distant.

Unassisted flight is understood as flight without assistance of an engine, neither to gain altitude nor to continue pure flight. Likewise it concerns aircraft that are lighter than the surrounding air. Flight without assistance of mounted fixed wings; the development within the sport of skydiving has continually made this dream closer to reality. Flights during free fall are independent of the aerodynamics required to land on the ground. This is made possible by the change of flight device before the phase of landing.

The invention is related to skydiving. More specifically it is related to combination of a skydive rig with an aerodynamic suit (wingsuit) to one unit: The wingrig FIG. 7-4.10.

### 2. STATE OF THE ART

Within the range of the invention the existing technology is twofold: The first part covers the skydiving rig (a) and its specific functions. The second part of the technology range covers the wingsuit (b) and other clothing, which purpose is to improve the flying properties related to extension of the horizontal portion of the flight. The two parts of the technology ranges are presented more in detail separately. One aspect of the present invention is to integrate these two parts/systems into one, thus it is important to show to what extent the two parts coincide in existing technology.
a) Skydiving Rig

The primary purpose of the skydiving rig is to stop the free fall, so that the jumper lands with much less vertical speed. The one thing that characterizes freefall flights from other flights is that you are forced to change flight devices between beginning and end. There are aspects related to this change that must be taken care of with safety as the highest priority. (Opening sequence) Section 4-3.00 FIG. 7-3.10

A skydiving rig consists primarily of 4 main components:

| | |
|---|---|
| Harness: | 4-1.10 text/7-1.10 fig. |
| Container: | 4-1.20 text/7-1.20 fig. |
| Closing mechanism: | 4-1.21 text/7-1.21 fig. |
| Canopy: | 4-1.30 text/7-1.30 fig. |

Harness

The harness is the load bearing part of the skydiving rig. It is this part of the equipment that absorbs and dissipates the forces from the opening sequence of the canopy. The weight of the jumper is secured by the harness during canopy opening, canopy flight and landing such that the user is securely attached to the rest of the skydiving rig.

The different components that are included in the harness are described in Section 4.1.10 and FIGS. 7.1.10 100 to 108.

Container

The container holds the canopy in a packed condition. A skydiving rig contains normally one or two canopies, packed respectively in one or two containers. Two canopies are required during skydiving from aircraft, a main canopy and a reserve canopy. The skydiving rig is called a “Piggyback” 4-1.31. When jumping from a fixed object (BASE jumping), the use of one canopy is the most common system 4-1.20. The different components that a container holds are described in 4-1.20 110 to 114 together with FIG. 7.1.20.

System of Closing the Container

The system of closing the container describes how the canopy 49 is secured in a packed condition. Canopy 49 is packed according to common procedures, and the packed canopy is secured in the container by means of pin(s). The pin(s) are connected to the release system, and the release system is initiated by the jumper. See 4-1.21 text/7-1.21 FIGS. 6 to 125.

The Canopy

Skydiving is dominated by the use of the so called “square canopy”, see 4-1.30 text and FIGS. 7-1.30 39 to 138. The canopy consists of a set of cells, open in the front, constructed with nylon fabrics. The surrounding air flow pressurises the cells so that a typical aerofoil is created. The wing foil is generating aerodynamic lift so that the vertical descent rate is reduced. Such square canopies expose considerable horizontal speed, which makes it possible to steer/control them. The control of the square canopy is done by changing the shape of the air foil, using the control lines and toggles 138/136 which are indirectly connected to jumper. This type of pressurized canopy is denominated a “ram air canopy”. A similar principle is used on paragliders and other air foils that are constructed without a rigid frame.

The Development of Aerodynamics in Skydiving

The container(s) in a skydiving rig are positioned flat on the back based on years of development. Smaller volume, safety solutions and improved freefall techniques have made the back position the preferred solution for the rig. Normally the skydiving rig contains a main canopy and a reserve canopy. See 7-1.40 Piggyback

The jumper's aerodynamics improved when the container system shifted from the belly mounted reserve, see 7-1.40 “Belly reserve”. The improvement of aerodynamics is presented schematically in FIGS. 7-2.20 150, 151, and 152 up to the technology level prior to the invention presented here, see FIG. 7-2.20 sketch 153, which deals with the wingrig, FIG. 7-1.40.
b) Wingsuits

A wingsuit is used for both skydiving and BASE jumping to increase the potential for horizontal movement during free fall. It helps the jumper's body to create a larger wing, thus generating more lift which enables a more gliding-like flight. Wingsuits are made of textile outstretched by the force of the jumper to create a larger area, section 4-2.10. Additionally, most suits use the adjacent air flow to pressurise the suit such that the surface is stabilized and given a form which improves the aerodynamics. See FIGS. 7-2.10 140 to 179.

Free fall without a wingsuit requires only one grip/motion to go from freefall mode to canopy flight, see “initiation of opening sequence” FIGS. 7-3.10 131 to 163. Freefall with a wingsuit FIGS. 7-2.10 140 to 179 limits the jumper's range of arm movement, given the size of the arm wings. This shows that the wingsuit requires at least one additional grip/motion before the jumper is ready to control the canopy and land.

The Development

The first suits that were developed to increase horizontal movement during free fall were introduced in the 1930s. Skydivers attending air-shows etc. used sail fabric with ribs/stiffeners to increase the wing area. Skydivers of that time were called “Bird Men”, and were considered pioneers in aviation, but it turned out that the suits had relatively poor performance. Over-complicated equipment and insufficient freefall competence where considered to be the main contributors to the high rate of accidents, and unfortunately many of the “Bird Men” died.

The wingsuit was not re-introduced until the early 1990s. A French skydiver, Patrick De Gayardon, started experimenting with suits that had nylon fabric between the arms and the body and between the legs. At the time the sport of skydiving had taken huge steps, from pre Second World War neck-breaking stunts, and became a sport with significant growth. The technology had gone significantly further; increased safety in general and significantly improved skills during free fall in particular. The rig at the time had, in principle, become smarter and simpler than previous designs (see FIG. 7-2.10). The wingsuits that Patrick De Gayardon developed are considered to be the basis for today's wingsuit designs.

Construction

The main characteristic defining all modern wingsuits is the pressurised wing profile 140 FIG. 7-2.10. The airfoil is similar to the ones used on square canopies and paragliders, which is defined by two layers of fabric. High pressure is created within the wing by the surrounding flow of air. This is called the “ram air” wing. The principle is based on air inlets in front or underneath the wing where the air can flow into the wing 140 and pressurize it. In this way the fabric of the wing surface is stabilised. Such wing construction is either connected to a tensioned suit or the complete suit where the jumper is inside the pressurised wing. It is vital for wingsuits that in addition to the “ram air” principle, the arms and legs are used as a rigid framework stretching the wing profile. The arms and legs are also used to determine the thickness of the wing profile.

Function

The primary function of the wingsuit is to improve the horizontal displacement of the jumper. This is obtained primarily by increasing the exposed area. At the same time it is beneficial to make the additional area as aerodynamic as possible so that the lift-drag ratio is optimised.

Measurements show that a jumper dressed in normal clothing could, with pure use of body shape, obtain a gliding angle around 45 degrees. A modern wingsuit can improve the glide angle to about 20 degrees. These figures assume stable flight where the absolute speed is kept constant.

Wingsuit designs of today solve the pilot chute access problems by decreasing the arm wing 140 area such that the user can move his hand around the trailing edge of the arm wing and reach the pilot chute handle. This is normally not an obstacle when it comes to finding the position of the pilot chute or when reaching around the hip to the pilot chute positioned at the bottom of the container. Some of the larger wingsuits have a pocket for the pilot chute on the suit itself, at a slightly lower position and closer to the bottom edge of the arm wing to ease access to the pilot chute. This also makes it possible to extend the length of the arm wing without interfering with the very important move to grip the pilot chute. Some of the larger suits have a stiff extended handle at the wing tip to extend the chord of the outermost section of the wing. The size of the wing extension handle is limited so as to not affect the access to the pilot chute.

Normally this gives an arm wing 140 which has a triangular shape extended between the shoulder, hip and hand. The thickness of the arm wing is more or less determined by the thickness of the jumper's arm, and in some cases the wings are made thicker than the size of the arm. The air pressurisation forms the wing into a three dimensional shape, where the typically 3-4 air foil shaped ribs inside the arm wing 140 help to define the air foil shape of the wing. The ribs are made of soft fabric, which limits the amount of camber that can be applied to the wing profile.

Some suits have ribs that are designed with a camber profile, but most suits have symmetric arm wing ribs 140. The angle of attack is therefore the primary tool to generate the desired lift.

Wingsuit jumpers today use two separate and different systems when they fly; the Piggyback rig (see FIG. 7-1.40) and the wingsuit (see FIG. 7.3.20). These two separate systems must function together. Existing wingsuits are more or less made to fit the functionality and safety of the rig, and less effort is made the other way around.

After deployment of the canopy it is vital that the jumper gets immediate control of the canopy. The steering toggles 136 FIG. 7-1.30 are placed one arm length above the head of the jumper. Access to these toggles is not possible before the arm wings 140 of the wingsuit are released by one or two hand movements 178 FIG. 7-3.20 or by zippers 179 or similar solutions. This phase of the jump is critical, and the sequence is required before jumper can handle any malfunction or control the canopy.

### 3. SUMMARY OF THE INVENTION

### Objectives of the Invention

Objective 1

The main objective with the present invention, the wingrig (see FIG. 7-4.10), is to provide a winged suit for free fall flight where the load bearing harness, container, canopy and suit are completely integrated to improve the aerodynamic performance in free fall.

Objective 2

The harness of the wingrig shall be arranged to “float” in the wingsuit, so that the harness does not have any fixed connection(s) with the wingsuit, and forces induced by movement of the jumper during free fall shall not affect any part of the deployment mechanisms.

Objective 3

The harness of the wingrig should appear as a unique or an independent part, so that it may be assembled/disassembled from the wingrig.

Objective 4

Forces introduced to the wingrig by the jumper changing position during freefall shall not be transferred to canopy release system.

Objective 5

Ensure a good ergonomic position for the jumper during free fall.

Objective 6

Be able to change the aerodynamic properties of the wingrig according to the requirements of the jumper.

Objective 7

Ensure safe container closing even though the pack tray area increases.

Objective 8

Generally, it is an objective of the invention to provide solutions to problems encountered in prior art.

Objective 9

A further objective of the present invention is to provide a wingrig FIG. 7-4.10 that simplifies the opening sequence of the canopy compared to existing solutions.

Objective 10

Forces introduced by arm wings during flight shall not be transferred significantly to the canopy release system.

Objective 11

Achieve a safe and stable connection between the arm wing itself and the rest of the wingrig (see FIG. 7-4.10).

Objective 12

Automatic release of the wings or other equipment during the opening sequence of the canopy.

Objective 13

Improve access to the pilot chute in packed condition, relative to the arm wing and the range of the arm itself (see FIG. 7-4.10 R).

Objective

The objective of the present invention is to optimize the aerodynamic performance of the jumper during free fall. Performance is primarily related to the jumper's ability to increase glide ratio by means of increasing the ratio between lift and drag 153 (see FIG. 7-2.20). At the same time it is vital that the wingrig is stable during different flight modes, i.e. longer horizontal flights and steep fast flights, but still keep similar stability and predictability. In this way the ability to maneuver, by means of controlling and steering, provides an optimum degree of freedom. It is also important that transitions from different flight angles are smooth so that loss of energy is minimized.

The ergonomic aspects are central in addition to the aerodynamics of the wingrig, and can be divided into two areas: user-friendliness during free fall, canopy opening and canopy ride, and the safety aspects in conjunction with the deployment, canopy control, steering and landing. The intention of the wingrig is to not apply any larger limitations to the movement of the jumper. The jumper should have the ability to make large changes to his position and movements of the body. Aerobatics such as somersaults, barrel roll and similar should not be constrained. This involves technical issues which are directly affected by rotation around “P”, the hip-joint (see FIG. 7-4.10). Rotation around “P” creates an extension of the peripheral radius, normally the part of the wingrig (see FIG. 7-4.10) which deals with the outer shell, from the neck/back over the buttocks and down to the fixation point at the feet (see FIG. 7-4.10).

The harness (see FIG. 7-7.30) will normally be secured and tightened to the user when the wingrig is ready to use. For ergonomic reasons during the wingrig flight, user freedom of movement should not be restricted. One issue is therefore not to affect the harness with forces introduced by the wingsuit. Likewise, forces introduced from harness at deployment or canopy flight should not to be transferred to the wingsuit. These objectives are primarily achieved by the “floating” harness. The layout of channels or leading structures in the wingrig (see FIG. 7-7.30) contain the harness with a large mechanical tolerance. The harness consists of webbing with buckles designed to conform to and secure the thighs and chest of the jumper (see FIG. 7-1.10). In order to provide the function of the harness, parts of the harness must be guided from a position close to the body and through planes of textile layers to reach the level where the canopy is stored and secured. The design implies introduction of slots such that the harness may reach said level.

The wingrig will (see FIG. 7-4.10), as for existing wingsuits, have limited mobility of the arms during flight. The jumper is not completely free to lift the arms high, as the arm wing 140 puts limits when it is mounted during flight, see FIG. 7-4.10 marked “R”. Opening of the winglock system 37 is presented in FIG. 7-3.30, enabling the jumper to control and steer the canopy without any other preparations.

The user-friendliness in relation to safety is evaluated on the basis of the possibility for the jumper to extract the pilot chute 131 unobstructed (see FIG. 7-3.30), and easily control, steer and land the canopy. The first element is taken care of through positioning of the pilot chute 131, so that the jumper has easy access to reach the handle in order to pull and throw the pilot chute into the adjacent air flow. The pilot chute must be placed so that the arm movement 160 FIG. 7-3.30 for reaching and gripping the pilot chute handle 131 FIG. 7-3 is not blocked by any part of the arm wing 140.

When the pilot chute inflates 131 FIG. 7-3.30, the wing profile 177 is released via a specific wing locking system 37 (see FIG. 7-8.10 A before and B after), which opens the container and extracts the canopy 49 from the wingrig. At this point, the jumper is ready to control the canopy without requiring any further actions (see FIG. 7-3.30). The released arm wings are constructed so that the jumper can easily reach the toggles 136, i.e. directly within the range to grab the toggles and use the full length of the steering lines.

The force generated by the pilot chute 131 FIG. 7-1.30 releases the arm wing locking system 37 (see FIG. 7-3.30). Other methods to release the arm wing, such as deployment of the canopy and its components, could also be used.

The risers 100 could also release the arm wing if they are attached to the locking system 37 (see FIG. 7-3.30) of the arm wing or as a locking device for another load, such as a pack or military cargo, where the cargo is secured to the wingrig during freefall and released from the jumper during or after the deployment process.

In addition to the objectives presented above, it is important that the wingrig in general has a high degree of functional safety. This means that the wingrig and all its components and connections must be built to withstand the high loadings that could occur combined with optimum performance.

### 4. SHORT DESCRIPTIONS OF THE FIGURES

4-1.00 Skydiving Rig

4-1.10 Harness

Jumper is mechanically secured, as shown in FIG. 7-1.10. Risers 100 gather the lines of the canopy, hold the weight of the jumper and open for access to the steering lines/toggles. Detachable mechanical locking system 101 located at the shoulders allows the canopy to be disconnected, or permanent connection between harness and risers 100 left and right. The risers 102 absorb the forces during opening of the canopy and the chest-strap 103 connects the left and right main lift webbing. The chest-strap is locked with a buckle. The hip cross-connection 104, using nylon or steel rings in the harness provides movement of the hip joint (marked “P” in FIG. 7.4.10). Buckle 105 (see FIG. 7-1.10) tightens and locks the leg strap 106. The extension webbing from the main lift joint 102 is directed backwards 107 and fixed at the centre of the lateral strap 108 in the lumbar region.

4-1.15 Detachable Floating Harness

Harness for the Wingrig: FIG. 7-7.30

The back strap of the harness 107 is directed through a layout of leading channel 65. Where leading channel 65 is located in the back element and is firm to the profile frame 22. Webbing surrounds the jumper via main lift riser 102 and connects to common hip joint 104 where the thigh strap 106 joins lateral webbing 108. Lateral webbing 108 is locked with an appropriate detachable mechanical connection device 67 to back webbing 107.

4-1.20 Container

A container with a packed canopy is presented in FIG. 7-1.20.

The upper flap 110 of the container covers and secures the upper part of the packed canopy. The right and left side flaps 111 cover and secure the sides of the packed canopy. The bottom flap 113 covers and secures the bottom part of the canopy. The locking mechanism of the container 112 holds the flaps 110, 111 and 113. Pocket 114 contains and secures the pilot chute.

4-1.21 The Locking Mechanism of the Container

Closed container with canopy in packed condition is shown in FIG. 7-1.21.

Pin Closed Container:

The locking loop 120 (see FIG. 7-1.21 pin closed container) is the upper locking loop of the container. It closes the upper flap 110 of the container together with the right and left side flaps 111 FIG. 7-1.20. The locking loop 6 FIG. 7-1.21 is the lower locking loop of the container. It closes the lower flap 113 of the container together with the right and the left side flaps 111 FIG. 7-1.20.

The bridle 123 FIG. 7-1.21 of the pilot chute 124 contains the locking pin(s), which lock the loops of the container. The bridle 123 is further connected to the canopy 130 FIG. 7-1.30 at the attachment point 122 and to the pilot chute 131 at the attachment point 123 FIG. 7-1.21. The opening sequence of the canopy is described later in section 4-1.30.

The bridle 123 FIG. 7-1.21 of the pilot chute 124 contains the locking pin(s), which lock the loops of the container. The bridle 123 is further connected to the canopy 130 FIG. 7-1.30 at the attachment point 122 and to the pilot chute 131 at the attachment point 123 FIG. 7-1.21. The opening sequence of the canopy is described later in section 4-1.30.

An alternative locking system for the container uses a Velcro™ flap 125 (see FIG. 7-1.21), which is connected to the bridle 123. The Velcro™ 122 connects the upper, lower and side flaps, which have the mating Velcro™. This system is the primary feature of a so-called Velcro™ rig.

4-1.30 Canopy

A flying ram air canopy is presented in FIG. 7-1.30.

The sketch in FIG. 7-1.30 shows a jumper flying a ram air canopy 130. The pilot chute 131 with attached 124 bridle 123 at the top skin 39 is thrown out in free air by the jumper to initiate the opening sequence of the canopy. The canopy 130 is pulled out of the container, then inflates completely and carries the load of the jumper.

The weight of the jumper is carried by fitted suspension lines 138 together with the steering lines and toggles 136. The lines are gathered and connected to the risers 100, which are part of the load carrying harness FIG. 7-1.10.

4-1.31 Historic Development

The historic development of the rig is schematically shown in FIG. 7-1.40.

Belly Mounted Reserve Canopy and Main Canopy:

Rig using two canopies where the reserve is positioned on the belly side of the jumper, used from the 1930s. Primary used by military personnel today.

Piggyback:

Two canopies positioned on the back of the jumper, used from the mid 1970s. The main and reserve canopies are integrated into one complete rig. The canopies are normally packed into a deployment bag system.

Single Parachute Container Rig:

Single canopy solution for BASE jumping (Building, Antenna, Span, Earth), first introduced in the mid 1980s. The canopy is normally free-packed, i.e. not using any deployment bag-system. Early models of the single parachute container rig were locked by means of Velcro™. Today pin-locking dominates.

Wingrig:

Suit to improve aerodynamic performance.

Different Pilot Chutes

The throw-out pilot chute: The pilot chute itself is thrown out in free air to initiate the opening of the canopy.

The spring-loaded pilot chute: Mechanically pretensioned pilot chute released by the jumper via a handle with a steel cable. Pin(s) are attached to the cable which releases the loop(s).

4-2.00 Wingsuit

4-2.10 Wingsuit

Suit to generate aerodynamic functionality, FIG. 7-2.10.

The arm wing 140 is located between the body and arm of the jumper, while the leg wing 141 is the wing located between the legs of the jumper. The wing joint 177 is the connection between the arm wing 140 and the body of the suit, which is manually released after deployment. A zipper system 179 or similar is normally used to free the arms from the arm wings. Handles 178 to release the arm wings at the wing joint could be located at both sides. Grip 145 is used to stretch/tension the arm wing during flight. The toe-/heel-fixation point 146 is used to stretch/tension the leg wing during flight. Air inlets 148 are used for pressurization of the arm and leg wings during flight.

4-2.30 Development of the Aerodynamics FIG. 7-2.20.

150 Belly reserve: Significantly decreases the aerodynamic functionality compared to intended performance of the wingsuit. 151 Piggyback: Unfavorable aerodynamic functionality compared to intended performance of the wingsuit. 152 Single container: Similar argumentation as for Piggyback 151. Wingrig: Aerodynamic optimization of the wingsuit and rig.

4-3.00 Initiation of the Opening Sequence

4-3.10 Single Container FIG. 7-3.10

Pull 160, movement of arm to deploy the pilot chute 131 usually with the right arm. Simultaneous movement of left arm 161 compensates for the aerodynamic asymmetry during the pilot chute pull. The movement that is required to reach the toggles 136 to control the canopy 7-1.30 130 is outlined through the axis of the shoulders 7-3.10 163 and the radius of the arm movement 162.

4-3.20 Single Container and Wingsuit FIG. 7-3.20

Pull 160, movement of arm to deploy the pilot chute 131 with the right arm. Simultaneous movement of left arm 161 compensates for the aerodynamic asymmetry during the pilot chute deployment. The movement that is required to reach the toggles 136 to control the canopy 7-1.30 130 is outlined through the axis of the shoulders 7-3.20 163 and the radius of the arm movement 162.

Wing joint 177 is between arm wing 140 and body of the suit. To release the arm wings 140 the jumper must reach the handles 178 in order to do the movement 162, which is required to control the canopy. Zipper locking 179 of the arm wing is an alternative/secondary release system.

4-3.30 Wingrig FIG. 7-3.30

Pull 160, movement of arm to deploy the pilot chute 131 with the right arm. Simultaneous and similar movement of left arm 161 compensates for the aerodynamic asymmetry. The arm movement 162 that is required to reach the toggles 136 to control the canopy 7-1.30 130 is outlined through the axis of the shoulders 7-3.30 163.

Wing joint 177 is between arm wing 140 and the body of the wingrig. The arm wings are automatically released during the opening sequence by wing lock system 37.

4-4.00 Wingrig

FIG. 7-4.10 Wingrig Axis

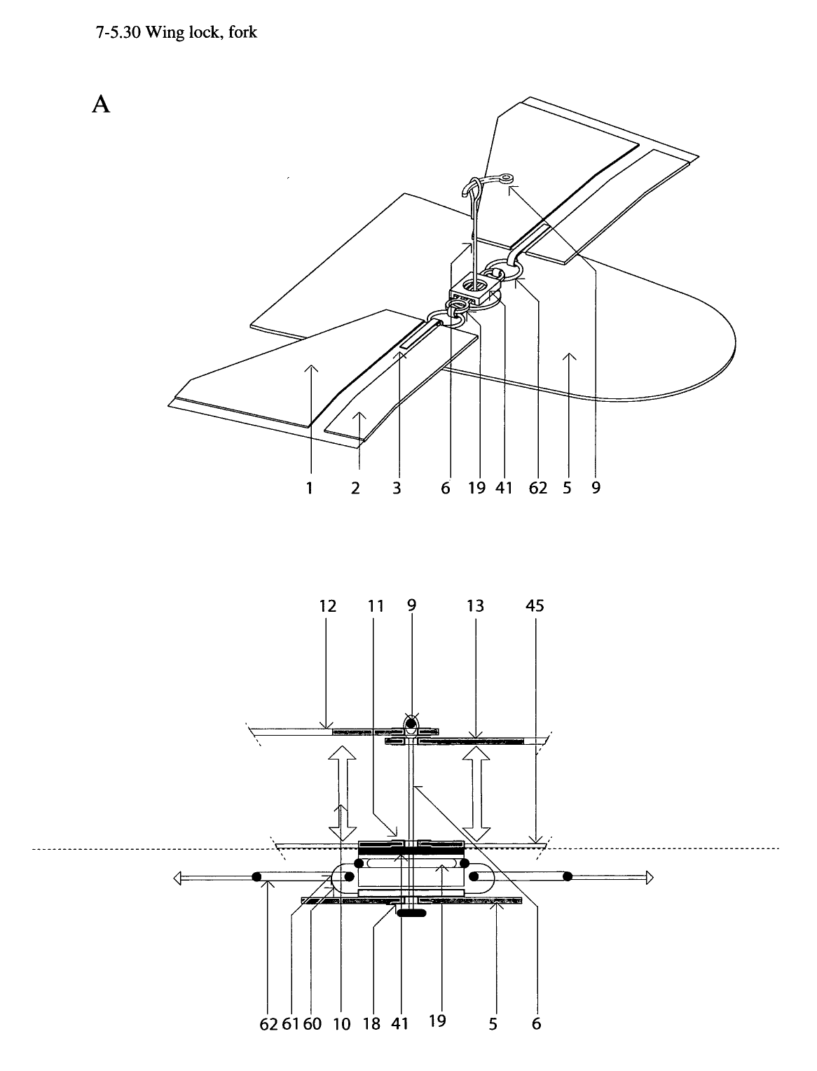

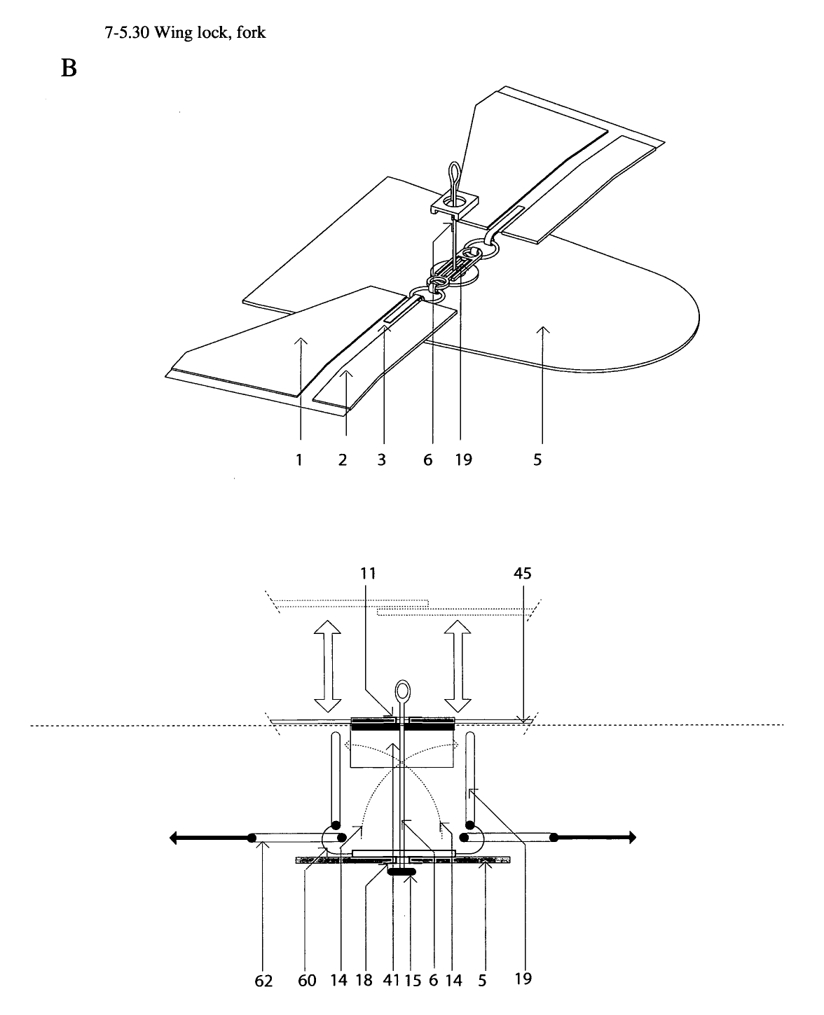

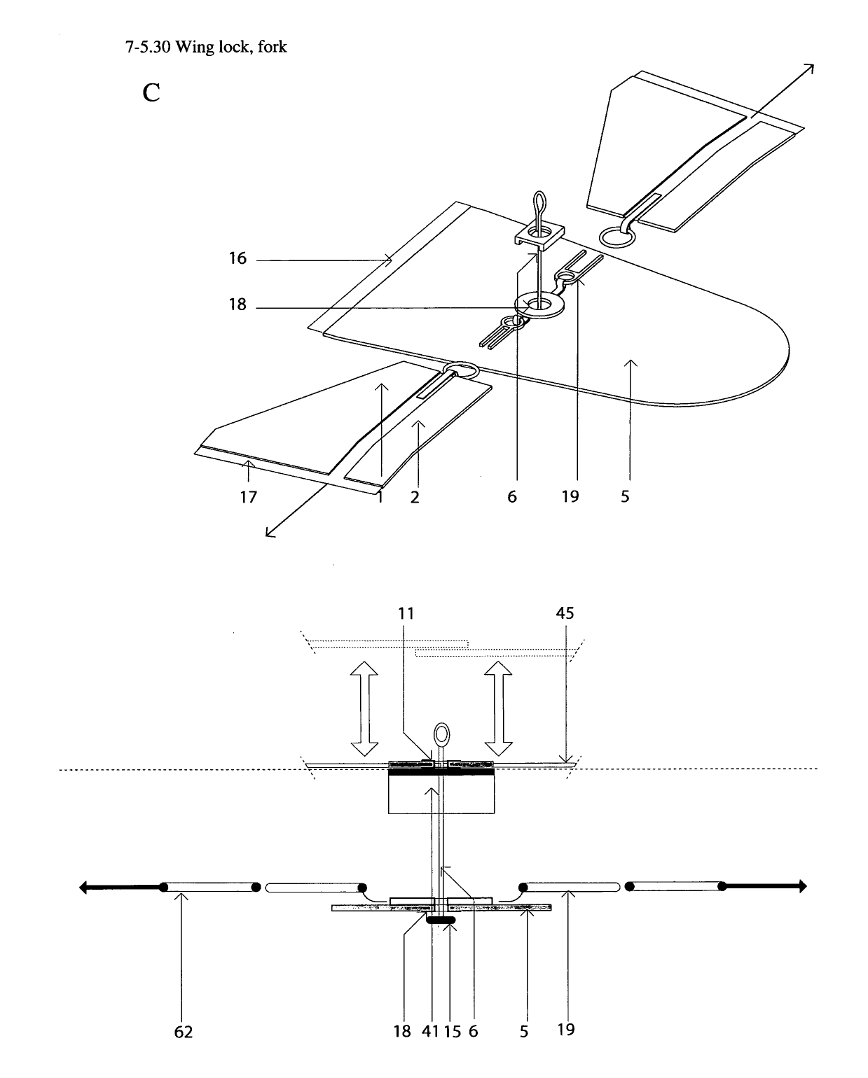

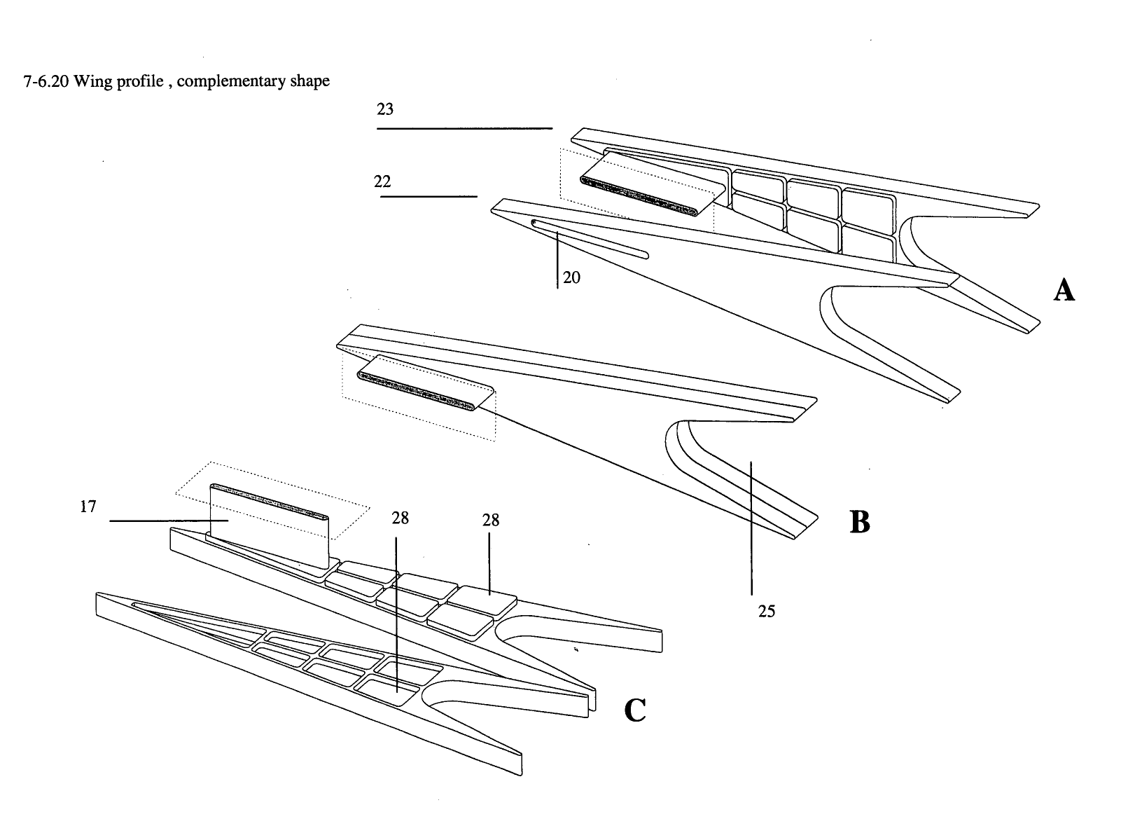

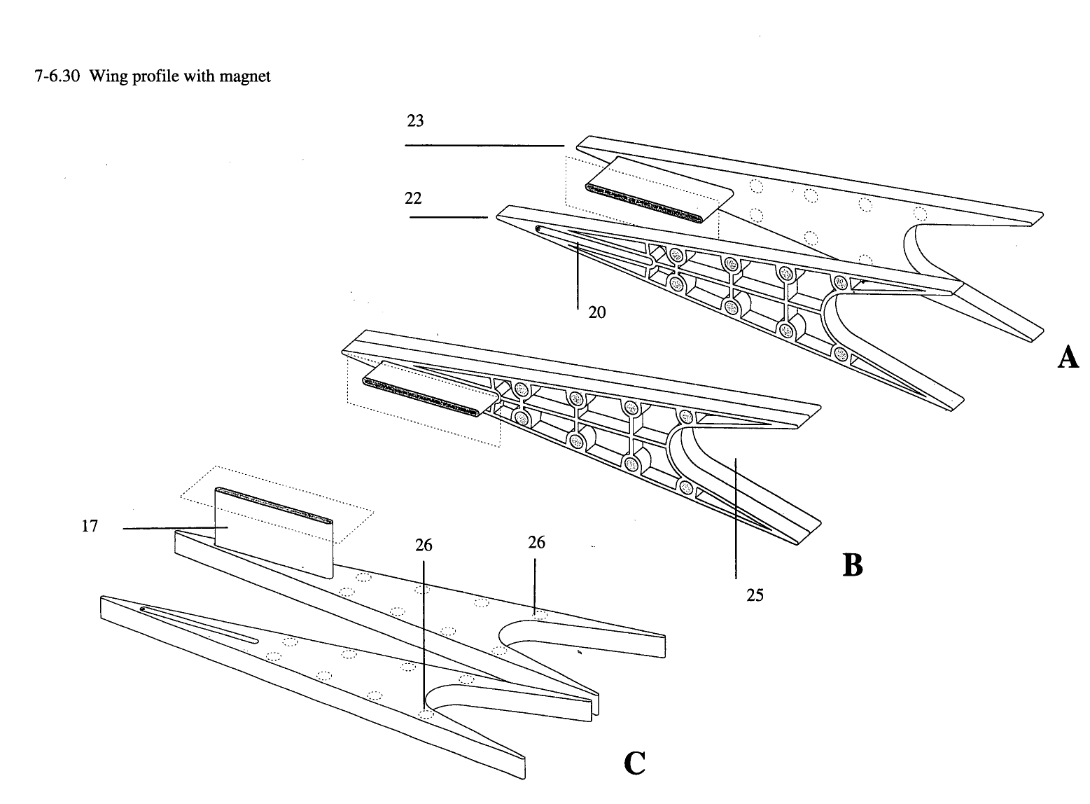

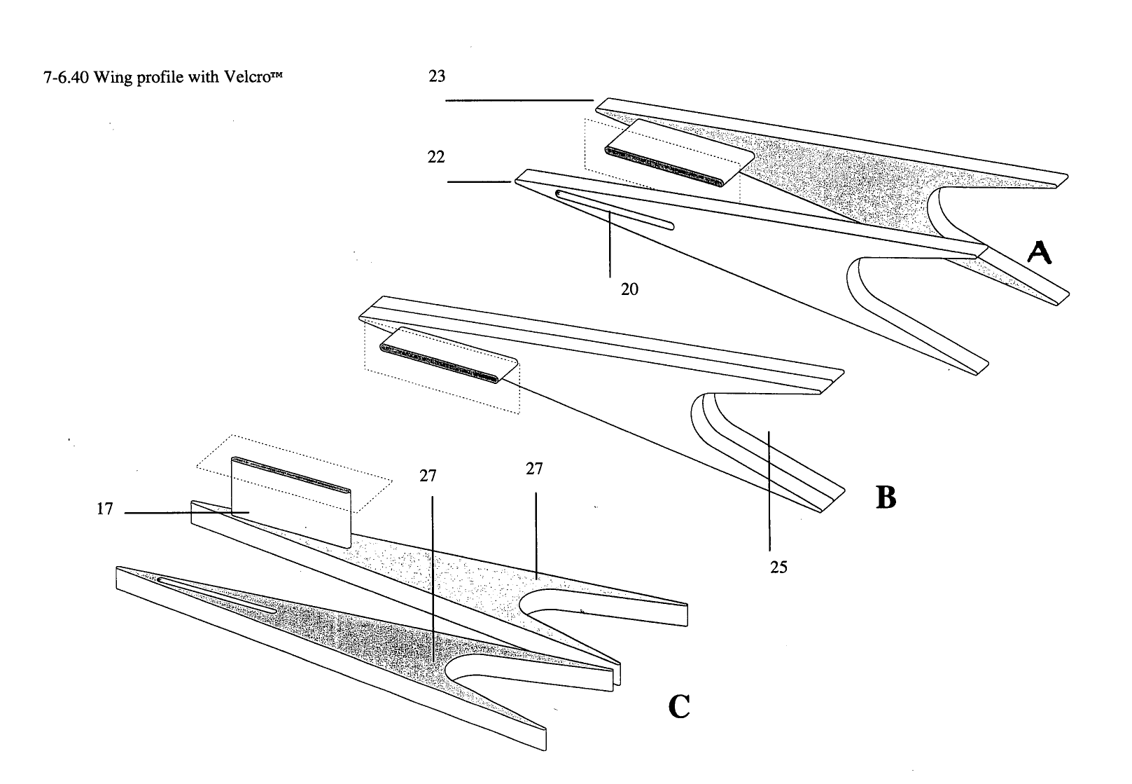

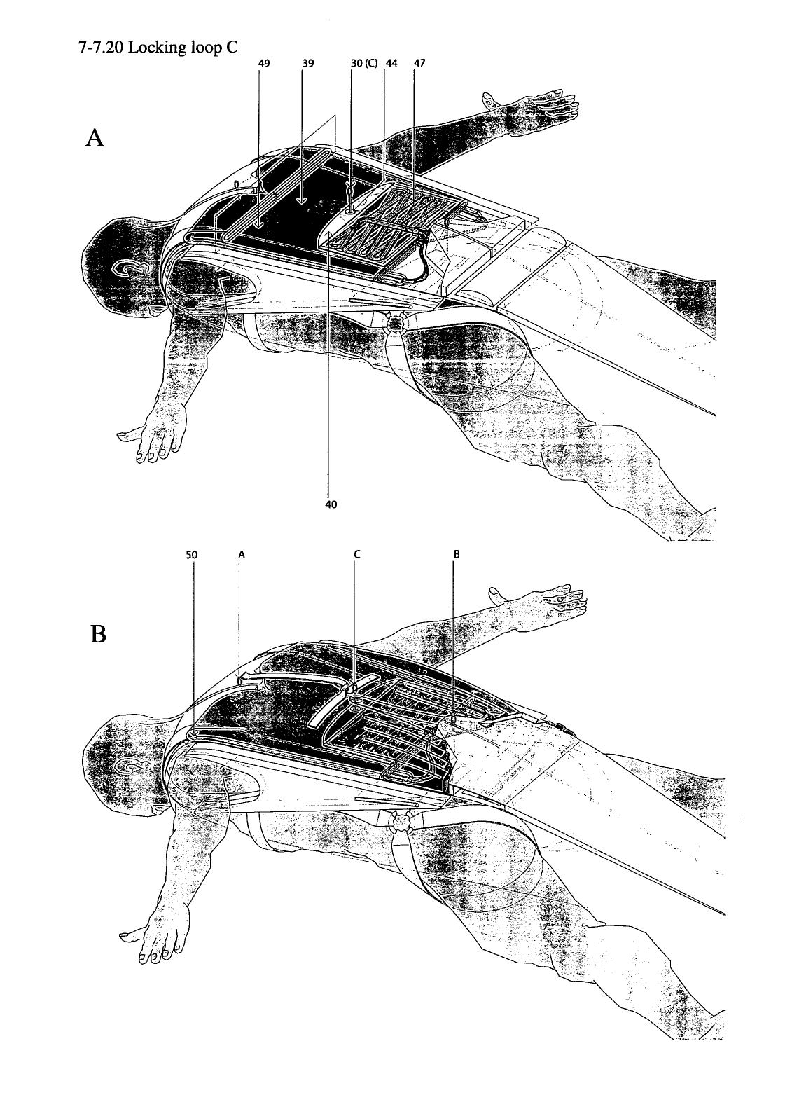

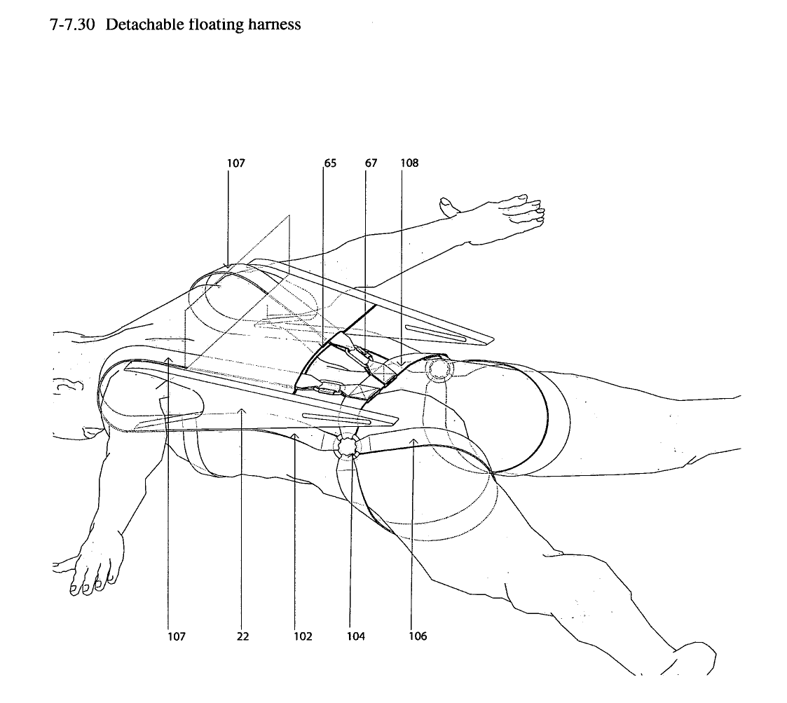

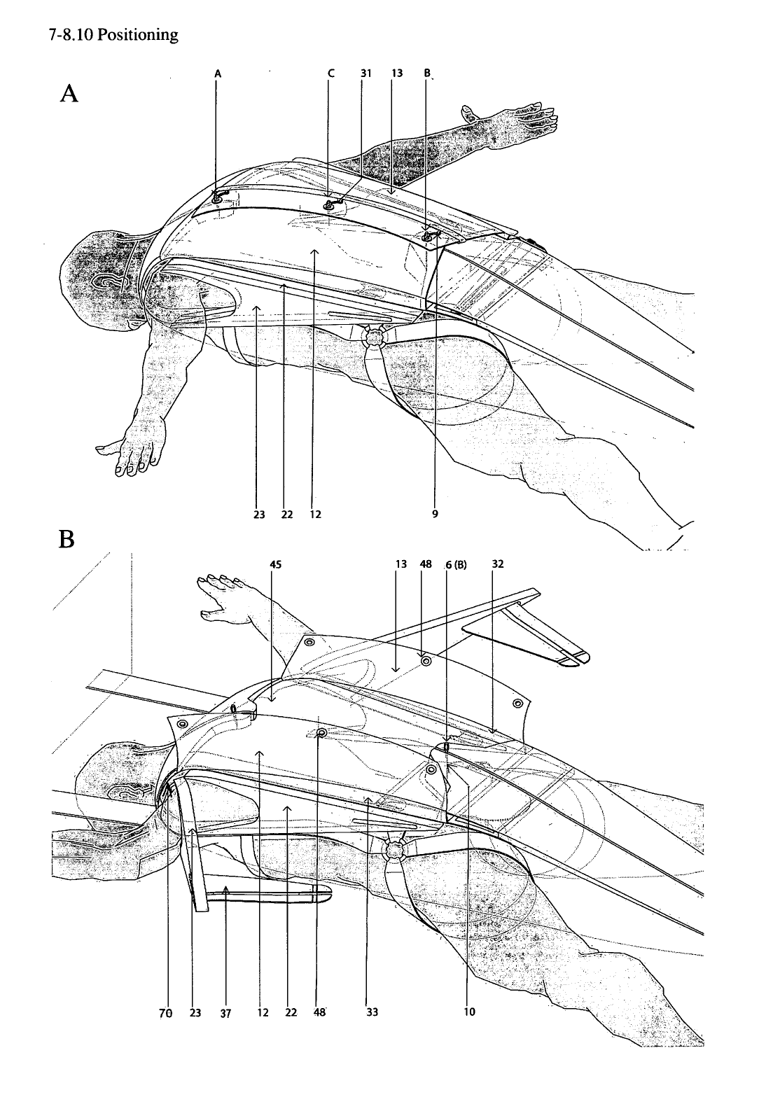

Loops A, B(6) and C(30) coincide with centre line 1. Loop B (6) (FIG. 7-8.10 A and B) locks the arm wing at axis B 7-4.10. Loop 30 (FIG. 7-7.20 A) is attached to the tail pocket 47 or top skin of the canopy at position C 7-4.10. Axis 1 centre line: The locking loops are positioned along axis and the wingrig is symmetric to this axis, except the opening of the pilot chute pocket. Axis 2 Chord line: Profiled semi-rigid frames on the right side, “profile frame 22” and “profile wing 23” are attached to this axis and create a base frame for the right arm wing. Axis 3 Chord line: Profiled semi-rigid frames on the left side, “profile frame 22” and “profile wing 23” are attached to this axis and create a base frame for the arm wings.

“P” hip: Rotation around position P. “R” displacement of arm: The movement of the arm when the arm wing is locked.

4-5.00 Wing Lock and Profiles

4-5.11 Wing Lock and Profiles FIG. 7-5.11 A and B

Wing lock 37. Mechanical locking/fixation 17 of profile wing 23. Upper and lower locking-plates 1 and 2.

Fixation point 16 for back plate 5 with loop B (6) fixed at grommet 18 to lock loop B (6) for wing lock 37. Guiding slit 20 is in profile frame 22. Fillet 25 fits the bottom of the jumper's arm.

Other possible wing profile base systems for mechanical stabilization: Profile base with complementary forms, FIG. 7-6.20. Profile base with magnets, FIG. 7-6.30. Profile base with Velcro™ attachment, FIG. 7-6.40.

4-5.21 Wing Lock, Locking Plates FIG. 7-5.21 A, B and C

A: Wing lock in locked condition. B: Wing lock during opening sequence. C: Wing lock open.

Split 3 with fabric tape connection of locking plates, upper 1 and lower 2 connected to tabs 7. Open split 4 for open guiding of locking loop B (6), which is secured with locking pin 9. Back flap 5, a plastic plate covered with fabric, with grommet 18 for fixation of washer 15 and attachment point of loop B (6) and is connected to the bottom of the pack tray at 16. (see FIG. 7-5.21 C) Rotation 14 (see FIG. 7-5.21 B) of hinges 8 between tab 7 and locking plates, upper 1 and lower 2. Padding 10 for vertical tension of locking loop B (6). Grommet 11 in the bottom of pack tray 45 (see FIG. 7-8.10 B). Left side flap 12 and right side flap 13 for fixation of packed canopy.

Attachment 17 (see FIG. 7-5.30 C) of wing lock 37 to wing.

4-5.30 Wing Lock, Fork FIG. 7-5.30

A: Wing lock in locked condition. B: Wing lock during opening sequence. C: Wing lock open.

Split 3 with fabric tape connection of locking plates, upper 1 and lower 2, connected to steel rings 62. Locking loop B (6) secured with locking pin 9. Fixation fundament 15, at back plate 5 of pack tray, is a plastic plate covered with fabric with grommet 18 for attachment of loop B 6. Rotation 61 of hinges at forks 19, guiding cage 41, and locking plate 5, upper 1 and lower 2. Padding 10 for tension of locking loop B (6) with guiding cage 41 for static positioning of the forks. Left side flap 12 and right side flap 13 for fixation of packed canopy. Attachment 17 (see FIG. 7-5.30 C) of wing lock 37 to wing.

4-6.20 Complementary Profile Shapes FIG. 7-6.20 A, B and C

Mechanical complementary shapes 28. The complementary shapes make the profile frame 22 and profile wing 23 with fillet 25 for armpit. Slit 20 of the profile frame 22 allows free escape of the locking plates, 1 and 2. (see FIG. 7-5.11 A and B) Wing lock 37 is fixed to the profile wing 23 at attachment 17.

4-6.30 Profile Shapes with Magnet FIG. 7-6.30 A, B and C

Magnets 26 are located inside the profile frame 22 and profile wing 23 with fillet 25 for armpit. Slit 20 in the profile frame 22 allows free escape of the locking plates, 1 and 2. (see FIG. 7-5.11 A and B) Wing lock 37 is fixed to the profile wing 23 at attachment 17.

4-6.40 Profile Shapes with Velcro™ FIG. 7-6.40 A, B and C

Velcro™ locking 27 of the profile frame 22 and profile wing 23 with fillet 25 for armpit. Slit 20 in the profile frame 22 allows free escape of the locking plates, 1 and 2. (see FIG. 7-5.11 A and B) Wing lock 37 is fixed to the profile wing 23 at attachment 17.

4-7.20 Locking Loop C FIG. 7-7.20 A and B

Canopy 49 in packed condition with fold 50 to which the centre locking loop C 30 is attached to the top skin 39 or at the tailpocket 47 with stiff base plate 40 and grommet 44.

B Loop B (6): Lower locking loop holds the wing lock 37. C Locking loop C 30: Centre locking loop is located on the tailpocket 47.

4-8.10 Assembly FIG. 7-8.10 A and B

Container back plate 45 with sidewall 32 and sidewall 33 connected to side flap 12 and side flap 13. Side flaps with grommets 48 for loop C 30 with locking pin 31. Arm wing hinge located at shoulder 70.

Loop B (6) with padding 10 for securing wing lock 37 FIG. 7-5.11 B is released by pulling out locking pin 9 FIG. 7-8.10.

### 5. DETAILED DESCRIPTION OF THE INVENTION WITH EXAMPLES OF DIFFERENT LAY OUTS

Harness

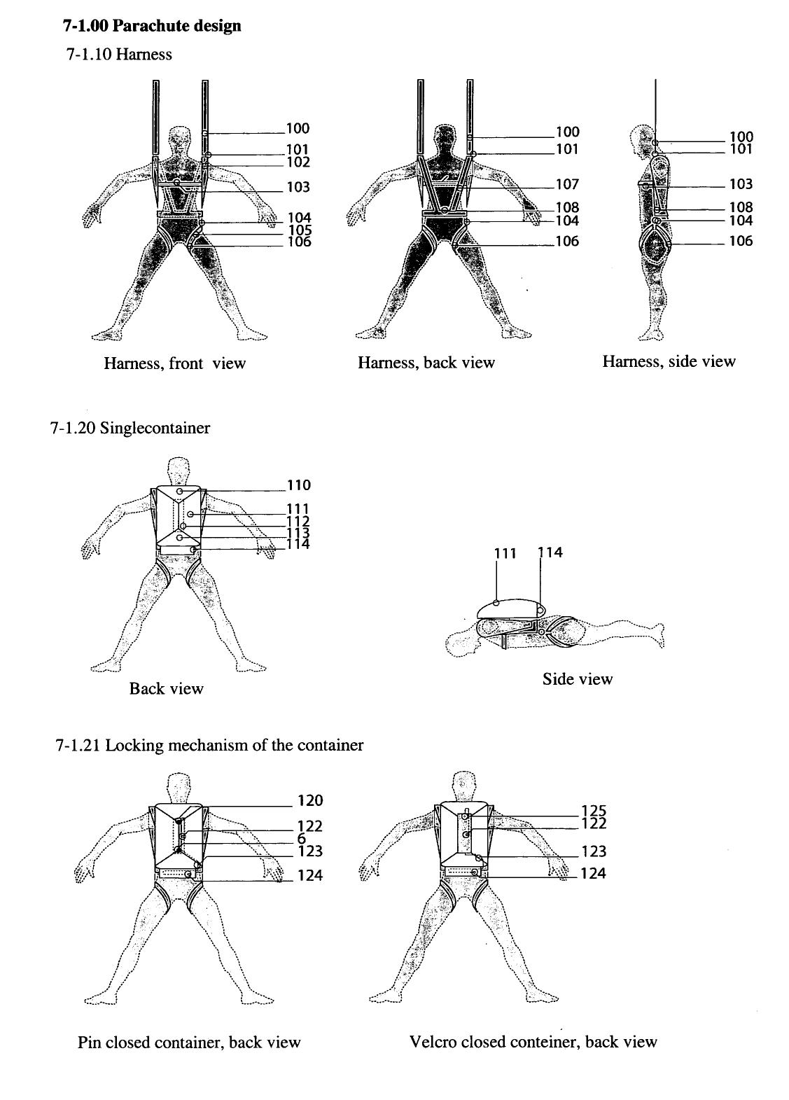

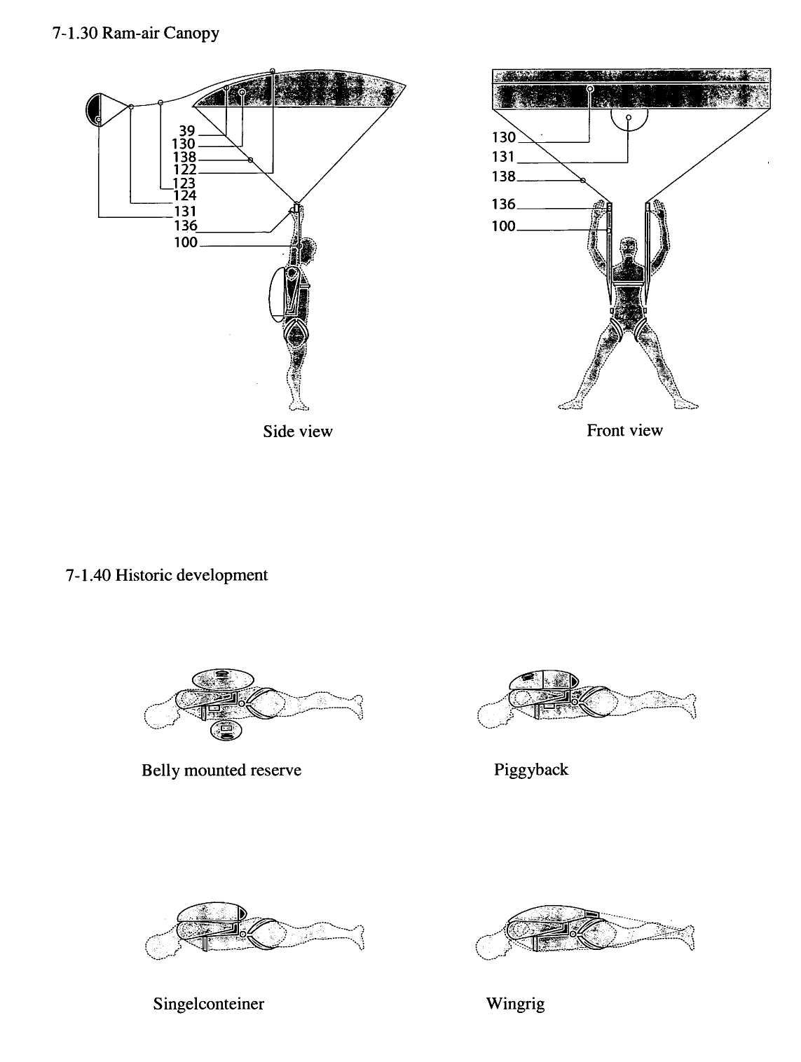

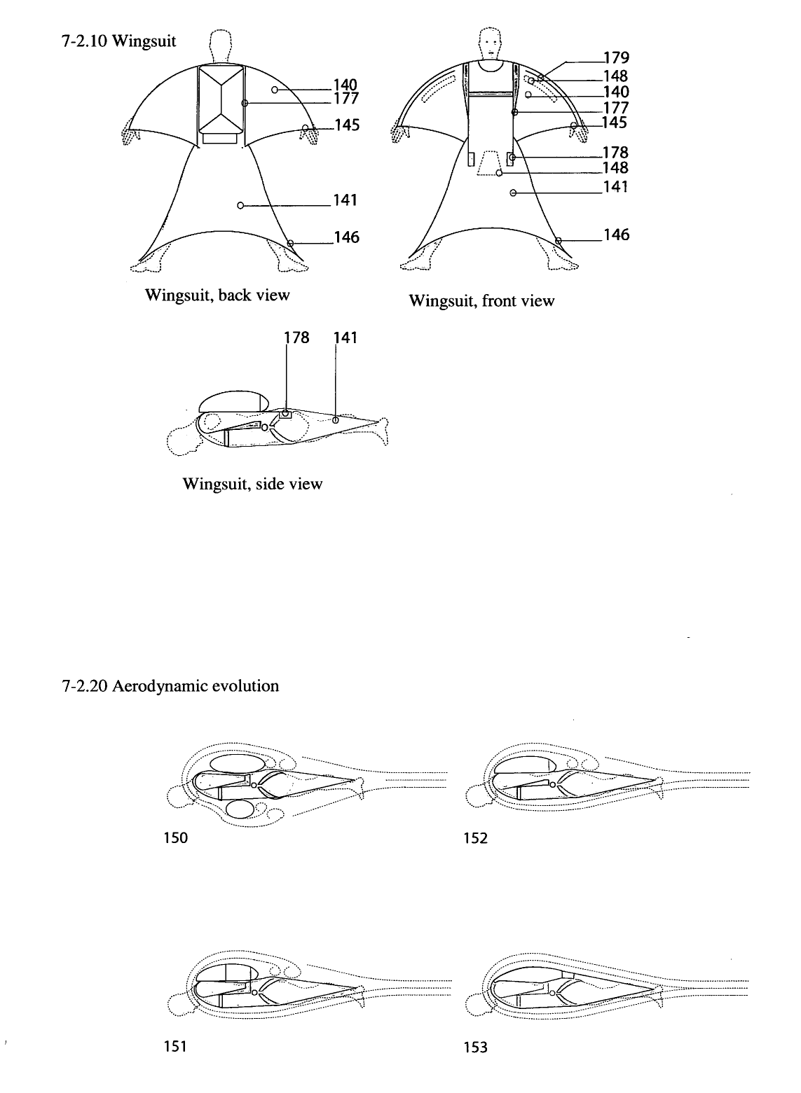

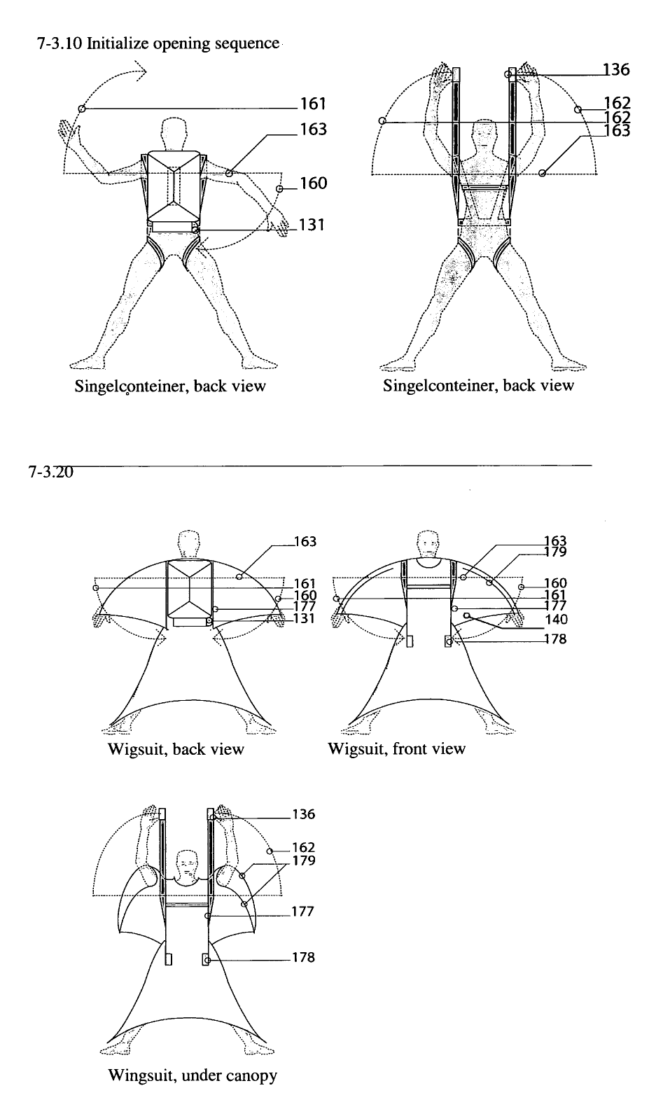

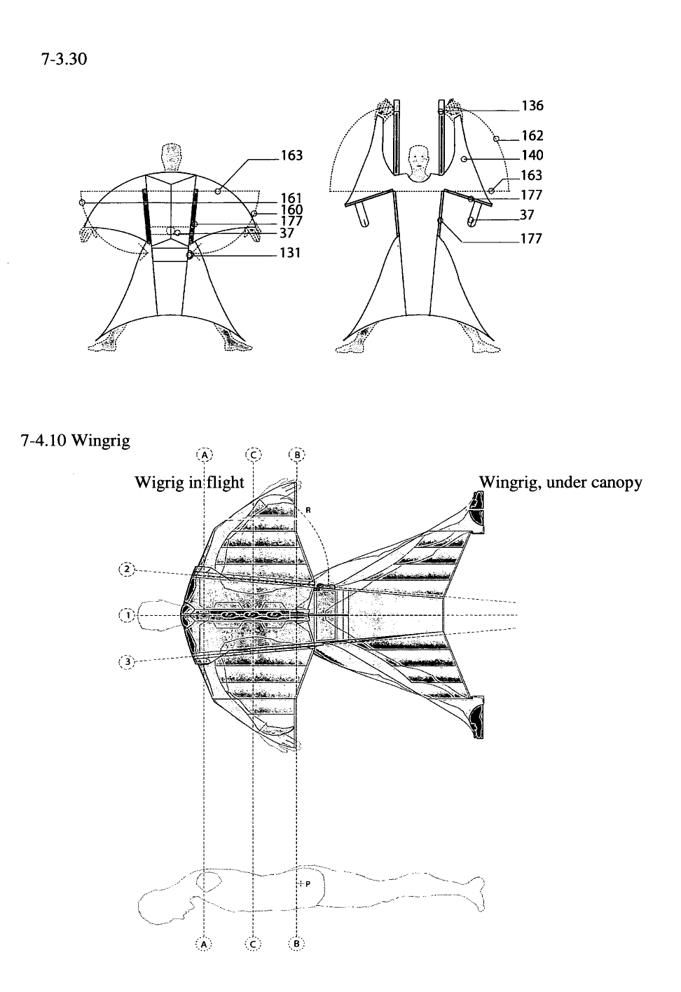

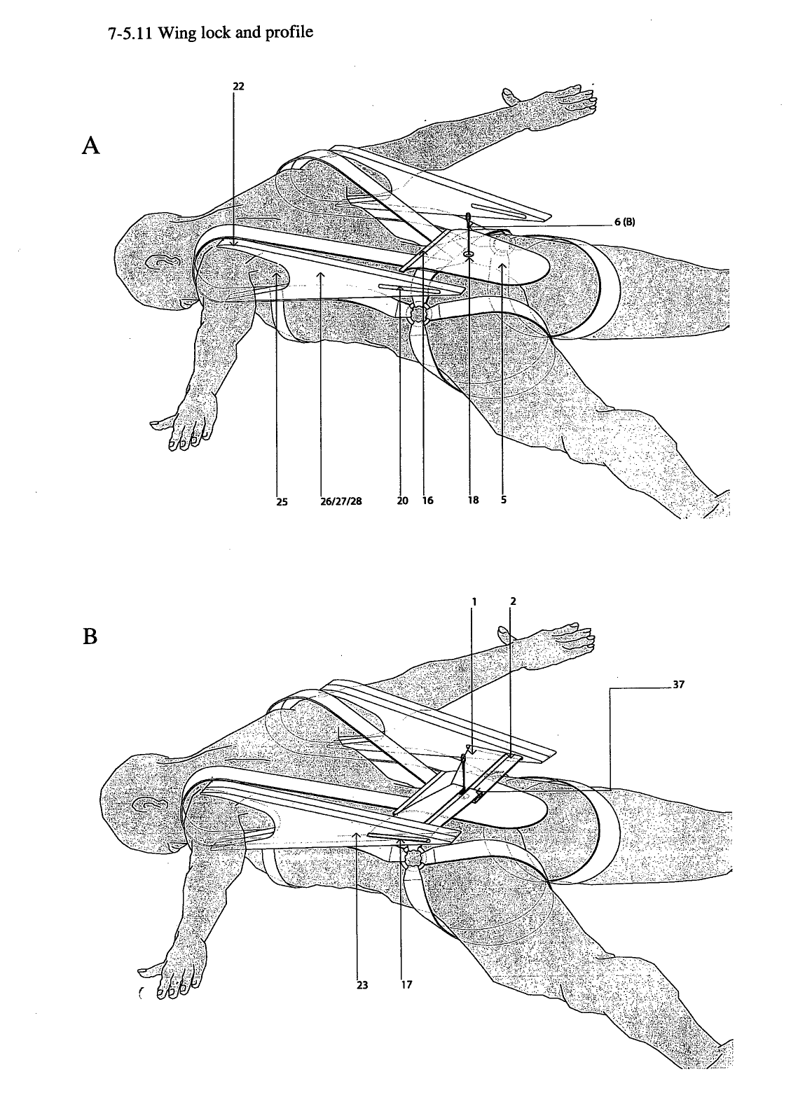

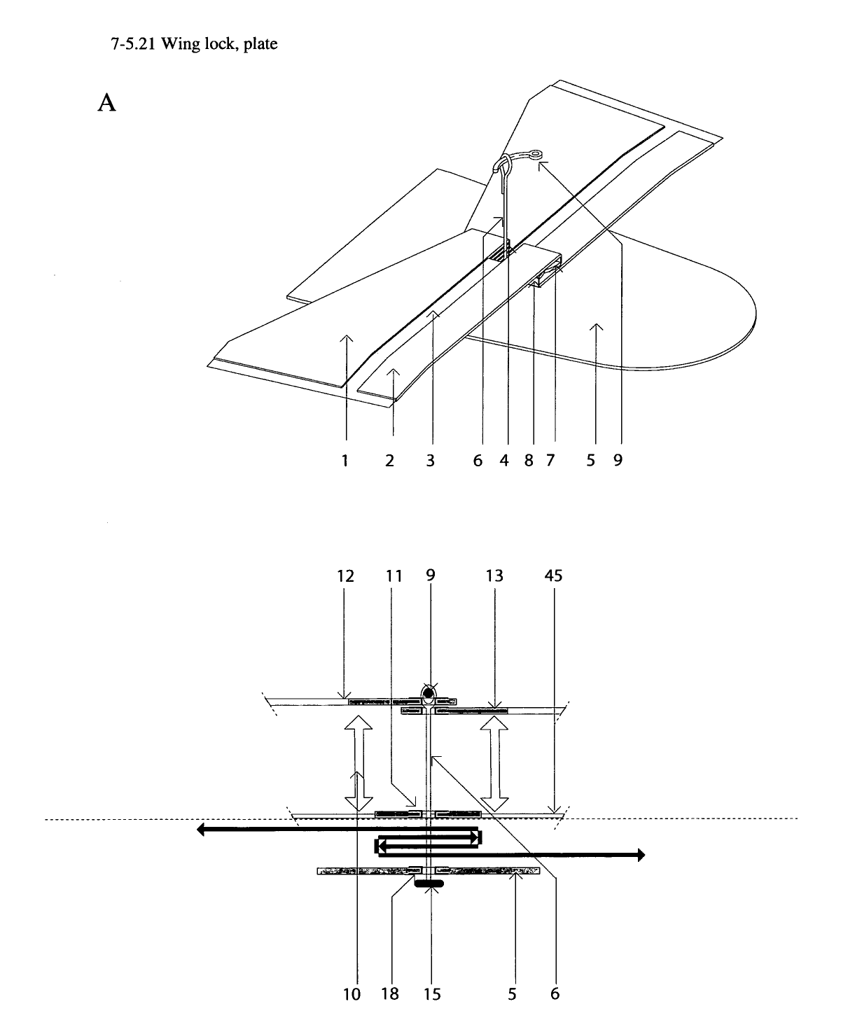

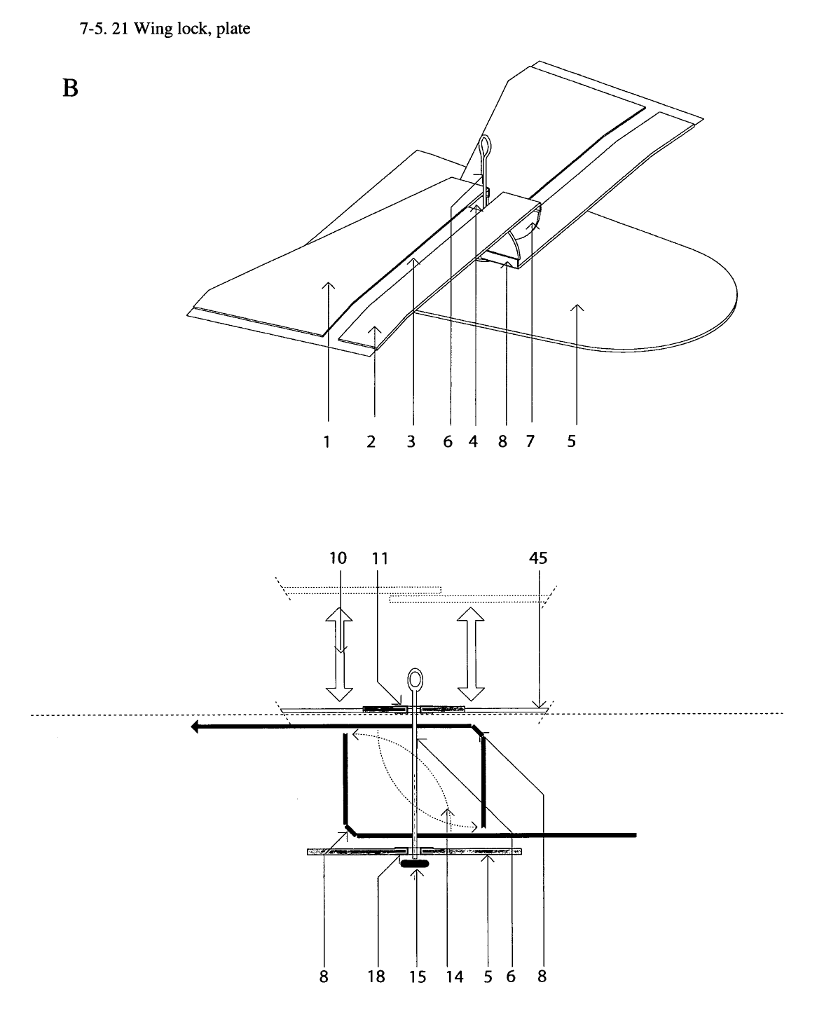

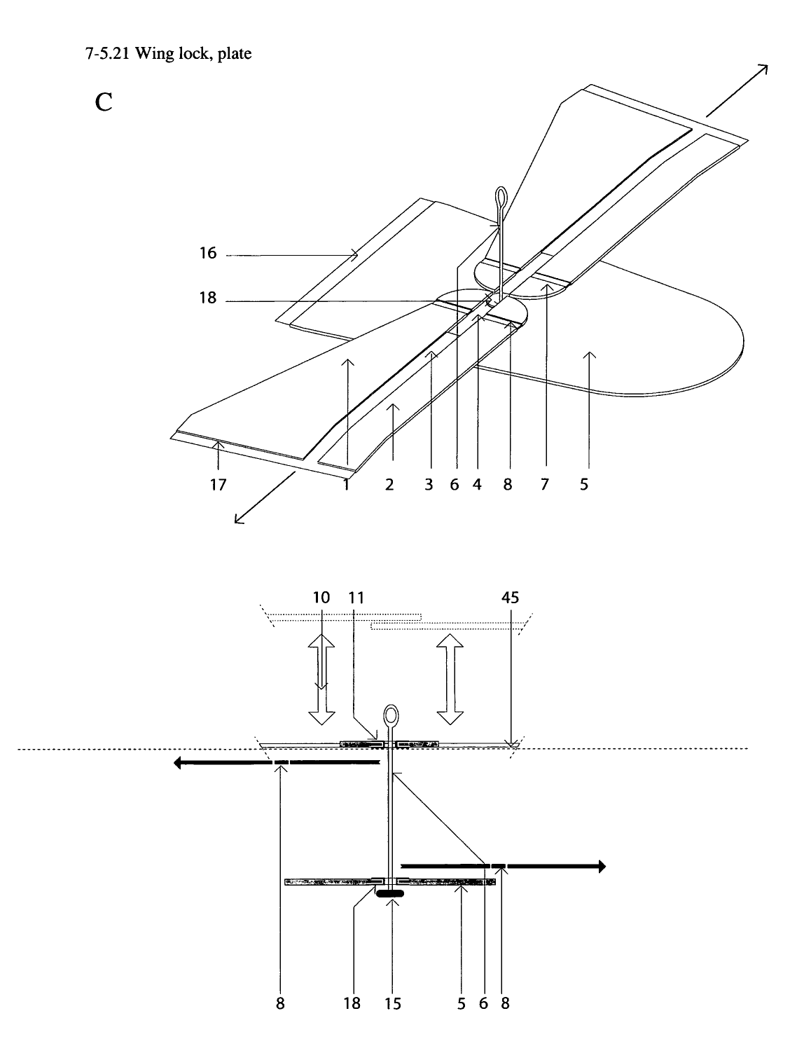

The wingrig FIG. 7-4.10 uses an internally mounted load bearing harness of nylon webbing. The wingrig has a layout of channel or tube as a leading structure in the layers of textile, arranged to receive and contain or guide the harness 65 (see FIG. 7-7.30). Leading channels are arranged to the back element 45 (see FIG. 7-8.10 B), where a gap to conduct the harness appears laterally, the gap being placed between the right and the left profile frame 22 (see FIG. 7-7.30) and firmly fixed to axis 2 and 3 (see FIG. 7-4.10). The front parts of the harness, such as the chest strap with buckle and the main lift risers located at the shoulder, follow the same principle as the leading channels for the lateral back element 65 (FIG. 7-7.30) where the webbing emerges from the leading textile channels. The leading channels partially encircle the harness, this layout resulting in a divided harness, the split 67 (see FIG. 7-7.30) being located at the back webbing 107. The separated harness is then lead into the leading textile channels 65. A locking device is introduced at split 67 so that it can connect and secure the back webbing 107 and lateral webbing 108.

The harness is closed and tightened with the strap in front, (see FIG. 7.1.10) right and left leg straps 106. The chest strap 103 is laterally mounted and attached to the load carrying risers 102.

Base Frame

The wing rig consists of a framework which consists of a base frame of nylon binding tape, FIG. 7.4.10 axis 2 and 3. The framework includes the shoulders and is guided to the hip, thus creating a frame which gives the wingrig its specific form and construction. This base frame opens for attachment of the profile frame and profile wing, 22 and 23, FIG. 7-8.10 A along the axis 2 and 3 in FIG. 7-4.10.

Container

The back plate 45 of the container is fixed to the base frame FIG. 7-8.10 B. The two vertical side walls, 32 and 33, of the container are also fixed to the base frame. The side flaps 12 and 13 are mounted to the side walls in a fitted fabric material. The side flaps hold the canopy in packed condition 49 FIG. 7-7.20. Adjustment of the size and shape of the side flaps, as well as position of the respective grommets and loops FIG. 7-8.10 A, B and C is used to form the aerodynamic profile of the rig.

Specific Elements:

Profiles and Wing Lock

Interlocking profiles FIG. 7-5.11 and B connect the arm wings with the body of the jumper so that tangential displacement of the wing-body joint is avoided during free fall. The wing profile is secured by a locking device 37 which connects the arm wing 140 FIG. 7-3.30 on the right side to the arm wing 140 on the left side and secures the wing laterally in the preferred position, see 37 FIG. 7-5.11 B.

Locking Loop C

The container locking loop C 7-7.20 FIG. A and B. Locking loop C is mounted on the canopy. Loop C closes the container, pulls the canopy 49 to the centre of the container, and fixes the tail pocket 47 and other parts of the canopy in place. Pre-tensioned loop C (30) is locked by means of locking pin 31, see FIG. 7-8.10 A.

Layout of Specific Elements

Plate Locking System

The position of the wing lock 37 of the wingrig FIG. 7-4.10 is shown in FIG. 7-5.11 A, and where the locking loop B (6) is the main component for the function of the wing lock 37. The aim of loop B (6) is to ensure safe locking of the wing locking system 37 and the flaps of the container FIGS. 7-8.10 A 12 and 13. Loop B (6) is mounted on plate 5 and is connected to the wingsuit, see FIG. 7-5.11 A.

The construction of the wing lock is shown in FIG. 7-5.21 A, B and C, the base of which is a part of back plate 5. Back plate 5 measures approximately 120×250 mm, and is made from 2 mm thick molybdenum disulfide nylon, polypropylene, or other suitable plastic material that is then covered with fabric, for example cordura. Plate 5 contains grommet 18 and is connected to the bottom of the pack tray 16. Loop B is made of high quality polyester or similar, and is connected at 15 FIG. 7-5.11 C below grommet 18 with a fixed length appropriate for the pre-tensioned function.

The extension on the narrow end of the profile wing 23 FIG. 7-8.10 B, and lateral plates FIGS. 7-5.21, 1 and 2, could be made of, for example, polypropylene covered with fabric. The lateral plates 1 and 2 terminate in a torsionally stiff material such as high strength aluminum, steel or titanium see FIG. 7-5.21 B. Plates 1 and 2 are connected via fabric tape 3 and end about 2-3 cm before hinge 8. An open wing lock is shown in FIG. 7-5.21 C.

The left locking tabs 7, FIG. 7-5.21 B, are guided to the centre line 1 on the wingrig. These are folded 180° at the hinge 8 and grip around the right locking tabs 7, which also is folded 180°. The rotation is shown in the cross sectional diagram FIG. 7-5.21 B. At this position, where the tabs 7 are folded together, a through thickness slit 4 is obtained FIG. 7-5.21 A. The folded tabs 7 are positioned so that the slit coincides with the grommet 18, and loop B (6) is guided through the slit 4 and further through the bottom of the pack tray 45 by grommet 11. Loop B (6) is shown in FIG. 7-8.10 B where it enters through the padding 10 FIG. 7-8.10 B and is guided through flaps 12 and 13 of the container.

When the locking pin 9 locks loop B (6), a static situation is obtained between the wing lock and the flaps 12 and 13 of the container, see FIG. 7-8.10 A. When the canopy of the wingrig is in the packed condition, the packed canopy 49 and the padding 10 applies an adjusted tension on loop B (6), which prevents the tabs 7 of the wing lock from rotating out of position.

Bridle 123 FIG. 7-1.30 pulls locking pin 9 FIG. 7-5.21 from locking loop B (6). The following outward movement of the jumper's arms will then release the wings when the folded tabs 7 are pulled and lifted apart by profile wing 23 FIG. 7-8.10 A and B, rotating on their respective hinges 8 as shown sequentially in FIG. 7-5.21 A, B and C. When the tabs 7 are separated, slit 4 will open completely and allow loop B (6) to escape freely.

Fork Locking System (Alternative Locking System)

The position of the wing lock 37 of the wingrig is shown in FIG. 7-5.11 B. Loop B (6) is the main component for the function of the wing lock 37.

The aim of loop B (6) is to ensure safe locking of the wing lock 37 and the flaps 12 and 13 of the container FIGS. 7-8.10 A, 12 and 13. Loop B (6) is mounted on back plate 5 and is connected to back of the pack tray 16, see FIG. 7-5.11 A.

The construction of the wing lock 37 is shown in FIG. 7-5.30 A, B and C, where back plate 5 is the base for the mechanism. Back plate 5 measures approximately 120×250 mm, and is made from 2 mm thick molybdenum disulfide nylon, polypropylene, or other suitable plastic material that is then covered with fabric, for example cordura. Plate 5 contains grommet 18 and is connected to the bottom of the pack tray 16 (see FIG. 7-5.30 C). Loop B is made of high quality polyester or similar, and is connected at 15 below grommet 18 with a fixed length appropriate for the pre-tensioned function.

The extension on the narrow end of the profile wing 23 FIG. 7-8.10 B and the upper and lower lateral plates 1 and 2 FIG. 7-5.30 B are made from a suitable stiff material covered with fabric and connect to the locking assembly with either fabric tape, a polyester loop, or a metal ring 62.

Locking plates 1 and 2 in FIG. 7-5.11 B are joined in 17 at the narrow end of the profile wing 23 where they could be fixed with rivets, sewing and/or glue to the frame at axis 2 and 3 FIG. 7-4.10.

The length of loop B (6) FIG. 7-5.30 C is adjusted to obtain proper pre-tensioned function. It is fixed below grommet 18 and is locked with knot 15. Fabric tapes 60 are attached to back plate 5 symmetric to grommet 18. Tapes 60 hold flat split-element forks 19, right and left, which can rotate freely as a hinge 61 through 180 degrees 61 FIG. 7-5.30 A, B and C.

The extension of profile wing 23, see locking plate 1 and 2, FIG. 7-5.30 B left side, fork 19 is threaded through loop 62 and is rotated towards and lies on top of grommet 18. The extension of the profile wing, right side, with locking plate 1 and 2, where fork 19 is threaded through ring 62 and is rotated towards and lies on top of grommet 18 so that the right and left forks 19 lie flat in the same plane.

Locking loop B (6) is threaded up through the split of the forks 19 and then through the bottom plate 45 of the pack tray FIGS. 7-5.11 B and 7-8.10 B where the locking cage 41 FIG. 7-5.30 A locks the forks 19, when loop B is tensioned. Loop B is shown in FIG. 7-8.10 B, where it comes up through the padding 10 and is guided through the flaps 12 and 13 in FIG. 7-8.10 A and locked with locking pin 9.

When the canopy of the wingrig is packed the canopy 49 FIG. 7-7.20 and padding 10 FIG. 7-8.10 A applies an adjustable tension on loop B (6) which prevents the fork connection 19 in FIG. 7-5.30 A from rotating out of position.

Bridle 123 FIG. 7-1.30 pulls locking pin 9 FIG. 7-8.10 A from locking loop B (6). The following outward movement of the jumper's arms will then release the wings when forks 19 FIG. 7-5.30 A are pulled and lifted apart by profile wing 23, rotating on hinges 61 as shown sequentially in FIG. 7-5.30 A, B and C. When the forks are separated the slit will open completely and allow loop B to escape freely.

Profiles

The wingrig profiles in axes 2 and 3 in FIG. 7-4.10 represent the joint/split between the profile frame 22 and profile wing 23 on each side, see FIG. 7-8.10. The semi rigid profiles are the mechanical joint between the jumper and arm wing 140 FIG. 7-3.30 during free fall. The aim of the profiles is to make an aerodynamic shape and a base for the arm wing to stabilize the wing under different loading conditions during flight. Forces are transferred through the profile pairs both from the user to the wing and the opposite. The profiles are semi rigid, which allows forces to be absorbed from several directions without directly transmitting the forces to the jumper.

The preferred solution is shown in FIG. 7-5.11 A, where the sketch illustrates the profiles positioned in relation to the wing lock 37, locking loop B and framework in FIG. 7-8.10.

The profile wing 23 FIG. 7-5.11 B is secured to the jumper by a wing lock system 37.

The profiles in FIG. 7-5.11 A show open slit 20 in profile frame 22 which guides locking plate 1 and 2. Profile wing 23 is guided and locked by loop B (6) The slit 20 in profile frame 22 is fitted for locking plate 1 and 2 so that movements during flight are minimized. FIG. 7-5.11 A shows body profile frame 22 with fillet 25 which fits below the jumper's arm.

Profiles of Preferred Construction: FIG. 7-6.20 (Complementary Shapes)

FIG. 7-6.20 A, B and C shows profile pairs 22 and 23 which have a complementary form fitted pattern 28. This, together with the wing lock 37 7-5.11 B, makes a stiff and rigid connection. The shape of the complementary pattern is optimized depending on the intended properties, which also involves material selection regarding stiffness and hardness. Currently, the preferred shape and properties are obtained with cast polyurethane with high tearing strength and hardness of approximately 70-90 SHORE A.

Profiles of Alternative Construction: FIG. 7-6.30 (Magnets)

FIG. 7-6.30 A, B and C shows how the connection of the profile pairs 22 and 23 is stabilized with magnet pairs positioned in the profiles. The profiles and magnets 26, together with the wing lock 37 FIG. 7-5.11 B make this type of connection stiff and rigid. Currently, the preferred shape and properties are obtained with cast polyurethane with high tearing strength and approximately 70-90 SHORE A hardness. The magnets are inserted into precise cavities in the cast profile which have been optimized for position as well as depth in the profile plane.

Profiles of Alternative Construction: FIG. 7-6.40 (Velcro™)

FIG. 7-6.40 A, B and C shows the profile pairs 22 and 23, and the Velcro™ 27 mating surfaces. The Velcro™ 27 and the wing lock 37 FIG. 7-5.11 B makes the connection stiff and rigid. The shape of the profiles and material selection regarding stiffness and hardness is changed according to the properties needed. Currently, the preferred shape and properties are obtained with cast polyurethane with high tearing strength and hardness of approximately 70-90 SHORE A.

Attachment of Loop C

The locking loop C (30) of the wingrig in FIG. 7-8.10 A compresses the packed canopy 49 FIG. 7-7.20 at the centre and closes the flaps 12 and 13 7-8.10 A of the container. An aerodynamic shape can be obtained, together with pre-tensioning of loop C (30) FIG. 7-7.20 A and B, and securing the packed canopy 49 FIG. 7-7.20 A, tailpocket 47 and the part of the canopy that is folded on top 50 FIG. 7-7.20 B.

The loop C (30) of the container is shown in FIG. 7-7.20 and is made of, for example, high quality polyester line with fixed length, attached at the centerline of the canopy either close to the tail at the top skin surface 39, or on the tailpocket 47 or through the canopy down to the back skin of the canopy. Loop C is fixed through grommet 44, which is secured in a stiff plate 40 of molydisulfid-nylon or other suitable plastic material. The canopy is protected and secured in the centre by flaps 12 and 13 and locked via grommets 48 FIG. 7-8.10 B. Loop C (30) is guided through grommet 48 to minimize the thickness of the packed canopy and to secure it when the locking pin 31 FIG. 7-8.10 A locks loop 30.

1-26. (canceled)

27. A wingrig for free fall flight and canopy flight of a jumper, comprising:
at least one canopy;
a harness comprising load bearing risers, back webbing, lateral webbing, tie straps and chest strap; and
a wingsuit comprising:
wings configured to be pressurized by surrounding flowing air, wherein the wings comprise arm wings configured to be released so that the jumper can reach a controlling system of the canopy, a suit for the jumper;
a container for at least one canopy, wherein the container comprises flaps; and
locking mechanisms which secure the at least one canopy in the container,
wherein the locking mechanisms of the container comprises at least one locking device which is connected to a release system configured to be released by the jumper, and
wherein the wingsuit is fitted to form at least one leading structure comprising a channel, a split, a loop or a ring, fitted to receive and enclose at least one element of the harness to contribute to align the wingsuit and the harness without being fixed static to one other, and configured to provide forward mobility between the wingsuit and the harness, and separation between the wingsuit and the harness.

28. The wingrig according to claim 27, wherein the leading structure comprises elements configured to enable the leading structure to open and close to receive or remove the harness element.

29. The wingrig according to claim 27, wherein the leading structure is arranged in connection to a first back element of the wingsuit, wherein the back element is arranged between a right and a left profile frame.

30. The wingrig according to claim 29, wherein the back element forms a part of the leading structure.

31. The wingrig according to claim 29, wherein the back webbing comprises right and left back webbing, and the leading structure further comprises a second back element which, together with the first back element, forms a divided opening arranged so that it simultaneously can receive both the right and left back webbing.

32. The wingrig according to claim 29, wherein the leading structure is fixed to the back element.

33. The wingrig according to claim 32, wherein the leading structure is configured so that at least one back webbing can enter.

34. The wingrig according to claim 27, wherein the harness comprises at least one mechanical coupling configured to be opened and closed manually, wherein the coupling is arranged to connect a part of the back webbing with another part of the back webbing, or a part of the back webbing with another element of the harness, and wherein said mechanical coupling forms a closed shape when it is locked and opens said closed shape when it is released, to allow the separation of the wingsuit from the harness.

35. The wingrig according to claim 27, wherein the wingrig comprises a wing lock which is arranged to mechanically connect the arm wings to each other, and wherein the locking mechanism of the container and the wing lock are arranged so that wing lock can be released by one grip/movement of the jumper, so that the at least one canopy is deployed and the arm wings are released from each other to start the transition from free fall flight to canopy flight.

36. The wingrig according to claim 27, further comprising a lock to secure other equipment in the form of a mechanical load, wherein the locking mechanism for the container and the lock for other equipment are arranged so that they can be released by one grip/movement by the jumper, so that the at least one canopy and the said other equipment are released.

37. The wingrig according to claim 35, wherein the locking mechanism comprise a shared locking loop (B), which is arranged so that it can contribute to lock locking systems of both the container flaps and the wing lock.

38. The wingrig according to claim 27, wherein the locking mechanisms comprises a mechanical connection to at least one of the risers in such a way that the release/opening of the at least one canopy transfers a mechanical force which releases the wing lock.

39. The wingrig according to claim 27, wherein the wingrig comprises a base frame that is configured to fit the body of the jumper, wherein said base frame further comprises at least two profile frames, wherein each of the profile frames is fitted to interact with an opposed profile wing so that a firm connection is obtained between the arm wing and the base frame.

40. The wingrig according to claim 39, wherein the connection between the arm wing and the base frame is fixed with either magnetic couplings, Velcro™ or complementary fitted shapes.

41. The wingrig according to claim 37, wherein the connection between the arm wing and the body of the jumper is tangentially fixed at a rear end of the arm wing at the hip by a locking mechanism which is released when the locking loop (B) is released.

42. The wingrig according to claim 39, wherein the leading structure comprises a split at the rear end of the profile frame that is open along the length axis to make free space for release and rotation of locking plates out of said split.

43. The wingrig according to claim 27, wherein the arm wings are exchangeable.

44. The wingrig according to claim 43, wherein the wingrig utilizes a connection for the arm wing and profile frame, wherein the connection is arranged at the shoulders and comprises a zipper, loop with locking pin, flat hole element with form of a ring or loop with button-lock or foldable stiffened fabric.

45. The wingrig according to claim 37, wherein the wing lock comprises at least two foldable locking elements, which are arranged so that they secure the wing lock when they are folded together and arrested in that position by guiding the loop through an opening in the locking elements so that the locking elements cannot be folded out of the arrested position when the container with flaps is in a pre-tensioned condition.

46. The wingrig according to claim 39, wherein the wing lock comprises two locking plates which make mechanical extensions to the profile wing, and wherein a tab made of torsionally stiff material ends at a perpendicular directed hinge at the locking plates, and wherein a split is arranged symmetrically between each of the two locking plates and tabs, so that when the tabs of the wing lock are secured when the two tabs are positioned and folded between the tabs and locking plate of an opposed wing lock, the wing lock can be locked with a locking system in the form of a locking loop which is guided through an open split which is created by the longitudinal splits so that the folded tabs cannot be unfolded from the locked position when the container is in a pretensioned condition.

47. The wingrig according to claim 39, wherein the wing lock comprises two locking plates which extend out to the profile wing, wherein a flat hole element comprising a ring or a loop is arranged at the end of the locking plates, wherein two flat fork like stiff metallic elements with an open split in the centre are mechanically connected and foldably arranged so that that the wing lock can be closed when the two fork element are guided through the hole elements and folded, and the wing lock can be secured when the loop is guided through the open split of the fork elements so that the folded fork elements cannot be unfolded out of the locked position when the container is in a pretensioned condition.

48. The wingrig according to claim 47, wherein the two fork elements are shaped so that the one element fits inside the other when the wing lock is in the locked position.

49. The wingrig according to claim 29, comprising at least one locking loop arranged to pull the packed canopy to the centre of the container, without being mechanically coupled to the back element of the container so that the container obtains a controllable aerodynamic shape when the loop is in a pretensioned condition.

50. The wingrig according to claim 49, wherein the locking mechanism of the container comprises locking loops, of which one or more of the locking loops are attached to the at least one canopy so that they leave the container during deployment of the canopy.

51. The wingrig according to claim 49, wherein at least one locking loop is attached to the centerline of the at least one canopy, close to the rear end of the canopy, either on a top surface or on a tailpocket or through the top and bottom surface of the canopy.

52. The wingrig according to claim 27, wherein the lateral webbing of the harness is not directly attached to the wingsuit so that the wingsuit can move in relation to the lateral webbing.
